(19) United States
(12) Patent Application Publication
(10) Pub. No.: US 2012/0050396 A1
(43) Pub. Date: Mar. 1, 2012

(54) LIQUID EJECTION RECORDING APPARATUS AND METHOD OF MAINTENANCE THEREOF

(75) Inventors: Hiroshi Yoshino, Kawasaki-shi (JP); Tsuyoshi Saeki, Kawasaki-shi (JP)

(73) Assignee: CANON KABUSHIKI KAISHA, Tokyo (JP)

(21) Appl. No.: 13/219,330

(22) Filed: Aug. 26, 2011

(30) Foreign Application Priority Data
Aug. 31, 2010 (JP) 2010-193573

(51) Int. Cl. B41J 2/165

(52) U.S. Cl. 347/29

(57) ABSTRACT

In a liquid ejection recording apparatus including a recording head capable of ejecting liquid and a cap capable of coming into contact with an ejection-port-formed surface, the recording head is caused to eject liquid from the recording head on to at least part (cap ribs) of the cap which comes into contact with the ejection-port-formed surface before bringing the cap into contact with the ejection-port-formed surface of the recording head.

### BACKGROUND OF THE INVENTION

1. Field of the Invention

The present invention relates to a liquid ejection recording apparatus (inkjet recording apparatus) and a method of maintenance thereof.

2. Description of the Related Art

In general, a liquid ejection recording apparatus includes a recording head configured to eject ink toward a recording medium to perform recording and a cap configured to adhere tightly to an ejection-port-formed surface (a surface where ejection port is formed) of the recording head and hermetically seal the periphery of the ejection port. The cap is provided for restraining the interior of the recording head, specifically, ink in the periphery of the ejection port from drying or for applying a negative pressure to the recording head to forcibly discharge ink. In order to achieve functions as described above, the cap is formed of a material having high hermeticity and low steam permeability in many cases. As an example of materials of the cap, chlorinated butyl rubber is exemplified. However, chlorinated butyl rubber has a high viscosity and is hard to be separated from the recording head once adhered tightly thereto in some cases, which may result in an operation failure. When using a cap formed of other materials, an operation failure such as leakage of the negative pressure due to poor adhesiveness between the recording head and the cap may occur, specifically, immediately after the start of use of the liquid ejection recording apparatus.

In order to cope with the problems described above, in Japanese Patent Laid-Open No. 9-76519, there is a description that the operation failure can be prevented by ensuring moderate adhesiveness between the recording head and the cap by forming an adhesive layer formed of liquid mixture in advance on a contact surface therebetween.

In the configuration disclosed in Japanese Patent Laid-Open No. 9-76519, since the adhesive layer is formed by applying the liquid mixture on the cap before shipment of the liquid ejection recording apparatus from the factory, there is a risk of separation of the contact layer during the transport or the storage after the shipment from the factory. If the contact layer is separated, the reliability which prevents the operation failure is lowered. In addition, since a process of forming the contact layer is necessary, increase in manufacturing cost of the liquid ejection recording apparatus is resulted.

### SUMMARY OF THE INVENTION

The present invention provides a liquid ejection recording apparatus in which moderate adhesiveness is given to a cap which comes into contact with an ejection-port-formed surface of a recording head, and the cap is prevented from becoming difficult to be separated from the recording head and a method of maintenance of the liquid ejection recording apparatus.

The present invention also provides a liquid ejection recording apparatus including a recording head which is capable of ejecting liquid, a cap which is capable of coming into contact with an ejection-port-formed surface of the recording head, and a control unit configured to cause the recording head to eject liquid to a portion of the cap which comes into contact with the ejection-port-formed surface before the cap is caused to come into contact with the ejection-port-formed surface.

Further features of the present invention will become apparent from the following description of exemplary embodiments with reference to the attached drawings.

### BRIEF DESCRIPTION OF THE DRAWINGS

FIG. 1 is a schematic side view of a principal portion of a liquid ejection recording apparatus according to an embodiment of the invention;

FIG. 2 is a schematic front view of the principal portion of the liquid ejection recording apparatus shown in FIG. 1.

FIG. 3 is a perspective view of a cap unit of the liquid ejection recording apparatus shown in FIG. 1.

FIG. 4A is a schematic cross-sectional view showing a cap-open operation of the cap unit shown in FIG. 3.

FIG. 4B is a schematic cross-sectional view showing a cap-close operation of the cap unit shown in FIG. 3.

FIG. 5 is a bottom view of an ejection-port-formed surface of a recording head of the liquid ejection recording apparatus shown in FIG. 1.

FIG. 6 is a block diagram showing a control system of the liquid ejection recording apparatus shown in FIG. 1.

FIG. 7 is a flowchart showing a method of maintenance of the liquid ejection recording apparatus according to the embodiment of the invention.

FIG. 8A to 8C are schematic cross-sectional views showing a process of preliminary ejection to cap ribs in the method of maintenance shown in FIG. 7.

FIG. 8D is a schematic cross-sectional view showing another example of the process of preliminary ejection to cap ribs.

FIG. 9 is a plan view of a cap of the cap unit shown in FIG. 3.

FIGS. 10A to 10D are schematic drawings showing the cap open operation after the process of preliminary ejection to cap ribs shown in FIG. 8A to 8C.

FIG. 11A is a plan view of the cap according to a modification of the liquid ejection recording apparatus in the present invention, and FIG. 11B is a cross-sectional view taken along the line XIB-XIB in FIG. 11A.

### DESCRIPTION OF THE EMBODIMENTS

Referring now to the drawings, an embodiment of the invention will be described in detail.

### [Basic Configuration of Recording Apparatus]

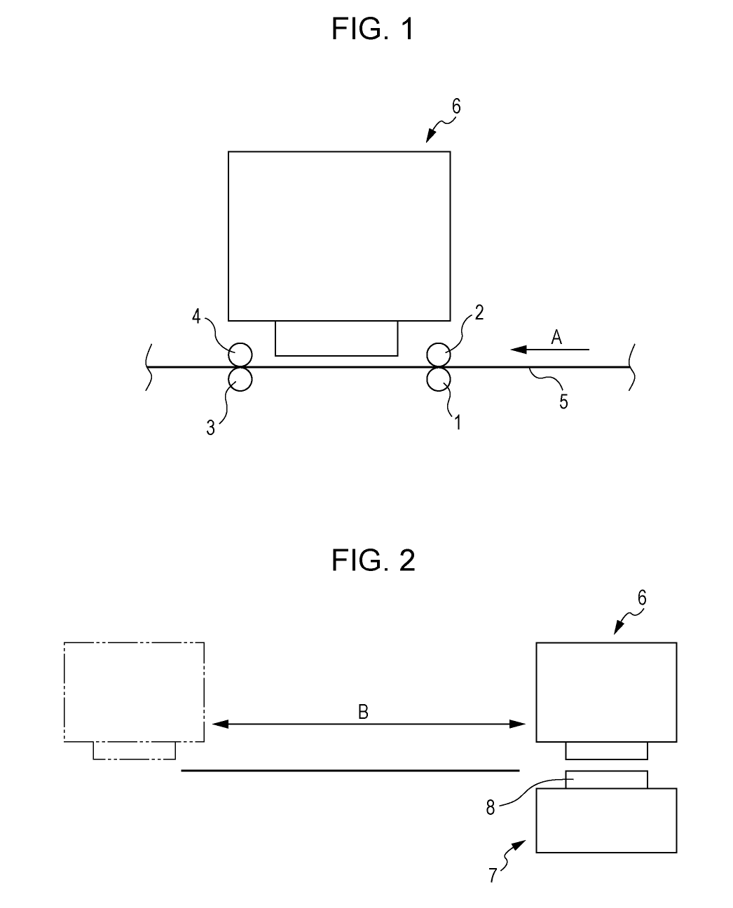

FIG. 1 is a schematic side view of a liquid ejection recording apparatus (inkjet recording apparatus) as an embodiment of the invention, and FIG. 2 is a schematic front view of the liquid ejection recording apparatus.

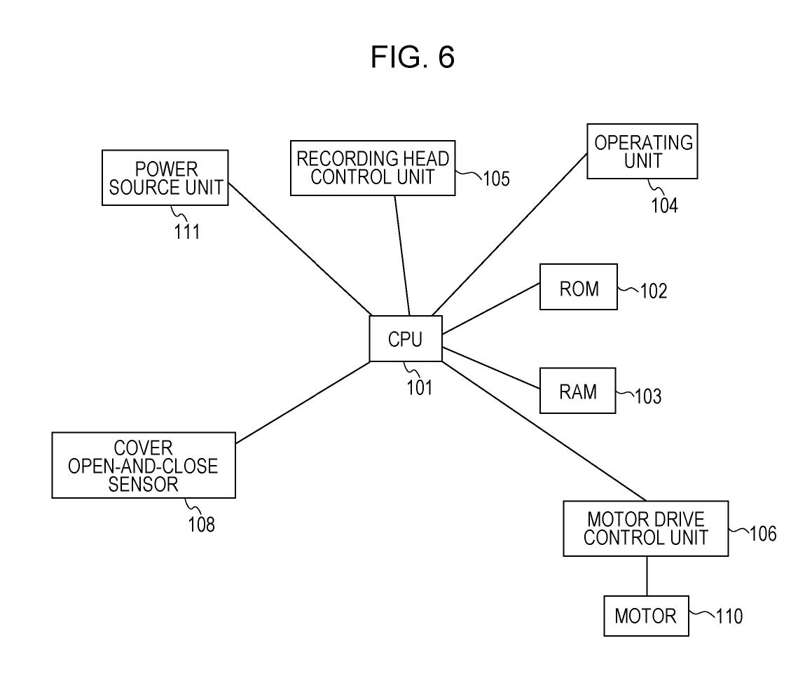

The liquid ejection recording apparatus according to the embodiment includes a conveying rollers 1, 2 and 3, 4 configured to transport a recording medium 5 in a direction A, a recording head 6 configured to be capable of ejecting ink droplets toward the recording medium 5, and a carriage (not shown) on which the recording head 6 is mounted. The carriage is capable of moving reciprocally in a width direction (a direction B) intersecting the direction of transport (the direction A) of the recording medium 5 by a driving unit including a guide member, not shown, and a motor 110 (see FIG. 6). Provided at the substantially center of a range of movement of the carriage in the direction B is a cover (not shown) configured to be capable of covering the recording head 6 and be openable and closable. Provided on the outside of the range of movement of the carriage in the direction B is a recovery unit 7 for performing maintenance of the recording head 6.

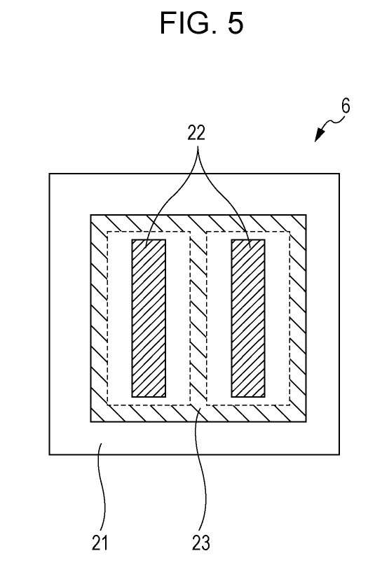

Provided in the recovery unit 7 is a cap unit 8, a pump unit (not shown) in communication with the cap unit 8, and a wiper unit (not shown). The cap unit 8 is capable of hermetically sealing ink ejecting portions (nozzle tip portions 22) by a cap 14 which is capable of coming into contact with a head face surface 21 (see FIG. 5) as an ejection-port-formed surface of the recording head 6. The pump unit is configured to apply a negative pressure to the nozzle tip portions 22 of the recording head 6 via the cap unit 8, and suck and discharge ink in the recording head 6. The wiper unit is configured to wipe off ink or the like adhered to the head face surface 21 of the recording head 6.

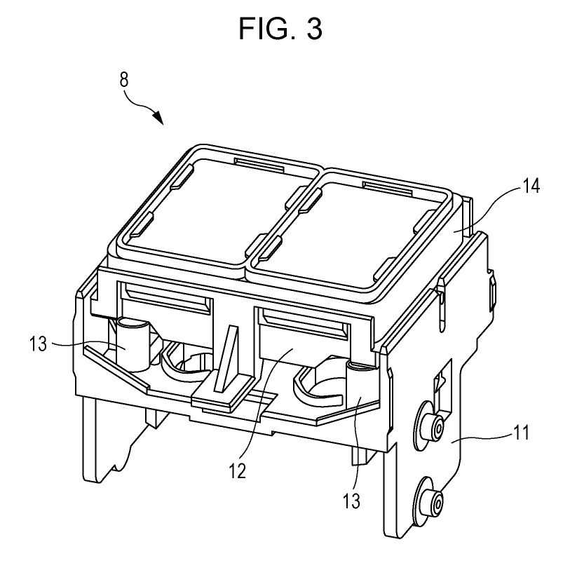

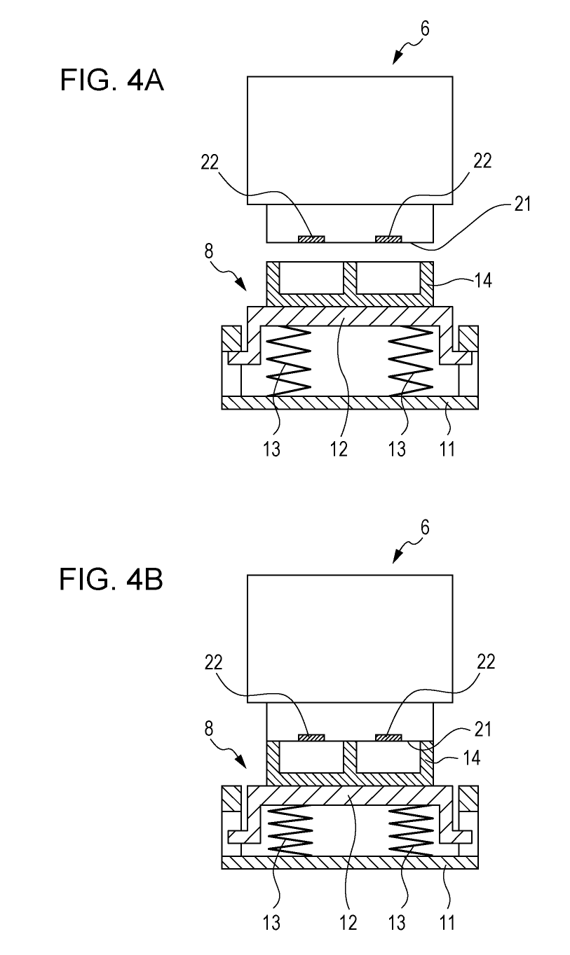

FIG. 3 is a perspective view of the cap unit 8, and FIG. 4 is a schematic cross-sectional view showing a cap-open operation and a cap-close operation of the cap unit 8. The cap unit 8 includes a cap base 11 as a supporting member for supporting the entirety of the cap unit 8, a cap 14, a cap holder 12 configured to fixedly support the cap 14, and a cap spring 13 positioned between the cap base 11 and the cap holder 12. The cap base 11 is driven to move upward and downward by a driving unit (not shown) including a motor 110 (see FIG. 6), and performs an operation to bring the cap 14 into contact with the recording head 6 (the cap-close operation) and an operation to bring the cap 14 away from the recording head 6 (the cap-open operation). When the cap base 11 is moved upward (the cap-close operation), the cap 14 is urged by the cap spring 13, and is adhered tightly to the head face surface 21 of the recording head 6 and hermetically close the head face surface 21. FIG. 4A shows an open state of the cap unit 8 before the cap-close operation, and FIG. 4B shows the cap unit 8 after the cap-close operation, that is, in the capped state. When the cap-open operation is performed from the capped state shown in FIG. 4B, the open state shown in FIG. 4A is restored again.

The positional relationship between the recording head 6 and the cap 14 will be described. FIG. 5 is a schematic bottom view of the recording head 6 shown in FIG. 2 viewed from the bottom. A bottom surface of the recording head 6 corresponds to the head face surface 21 facing the recording medium 5, and includes nozzle tip portions 22 formed with nozzles each including an ejection port. Part of the head face surface 21 corresponds to a contact portion 23 which comes into contact with the cap 14. In the capped state shown in FIG. 4B, the cap 14 adheres tightly to the contact portion 23, and hermetically seals the nozzle tip portions 22.

FIG. 6 is a block diagram showing a configuration of a control system of the liquid ejection recording apparatus according to the embodiment. The control system is provided with a CPU (Central Processing Unit) 101 configured to exercise control of the entirety of the liquid ejection recording apparatus. A power source unit 111, a recording head control unit 105, an operating unit 104, a ROM (Read Only Memory) 102, a RAM (Random Access Memory) 103, a motor drive control unit 106, and a cover open-and-close sensor 108 are connected to the CPU 101. The motor 110 is connected to the motor drive control unit 106. Although FIG. 6 shows as if there is only one motor 110, a plurality of the motors 110 for moving the carriage, for driving the conveying rollers 1, 2 and 3, 4, for driving the cap base upward and downward are connected and are controlled respectively.

### [Basic Operation of Liquid Ejection Recording Apparatus]

Subsequently, a basic operation of the liquid ejection recording apparatus according to the invention having the configuration as described above will be described.

First of all, a mounting operation (head installation operation) of the recording head 6 to the liquid ejection recording apparatus will be described. In the embodiment, when the liquid ejection recording apparatus is not used (at the time of shipment), the recording head 6 is in the state of not being mounted on the liquid ejection recording apparatus. When a user turn on the power of the liquid ejection recording apparatus and open the cover prior to the use of the liquid ejection recording apparatus, the carriage for mounting the recording head 6 is moved to a position near a cover opening. In this state, the user sets the recording head 6 on the carriage and close the cover. When the cover open-and-close sensor 108 senses the fact that the cover is closed, a predetermined head installation operation is performed. Although the main characteristic of the invention is in the head installation operation, only an outline of a general head installation operation will be described here, and the characteristic part of the invention will be described later.

In general, a sucking operation, a preliminary ejecting (preliminary ejection for recovery) operation, and a wiping operation are performed as the head installation operation. More specifically, a cap-close operation which causes the cap 14 of the cap unit 8 to adhere tightly to the head face surface 21 of the recording head 6 at a portion in the vicinity of the nozzle tip portions 22 is performed. Subsequently, the sucking operation which drives the pump unit to suck ink or the like from the recording head 6 is performed. Subsequently, the cap 14 is moved away from the head face surface 21 (the cap-open operation), ink in the nozzles of the recording head 6 is ejected from the ink ejecting portions to a place other than the recording medium 5, old ink in the nozzles is discharged, and new ink is filled in the nozzles. Then, as the wiping operation, excessive ink adhered to the nozzle tip portions 22 of the head face surface 21 and the portion in the vicinity thereof is wiped off with a wiper. When the head installation operation is completed, the cap-close operation to cause the cap 14 to adhere tightly to the contact portion 23 and hermetically close the nozzle tip portions 22 is performed again, so that the cap gets into the capped state (see FIG. 4B). This corresponds to a recording standby state.

Subsequently, the printing operation will be described. When the user operates the operating unit 104 or a computer connected to the liquid ejection recording apparatus to issue a record command, the cap base 11 is moved downward first by the driving unit, not shown. Accordingly, the cap 14 moves away from the head face surface 21 of the recording head 6, and gets into a state in which the head face surface 21 is opened (see FIG. 4A) (Cap Open). Subsequently, the recording medium 5 is transported by the conveying rollers 1, 2 and 3, 4 in the direction A, and is moved to a position where recording by the recording head 6 is possible (see FIG. 1). Then, while the carriage moves in the width direction of the recording medium 5 (direction B), the recording head 6 ejects ink droplets at adequate timings toward the recording medium 5 according to signals from the recording head control unit 105. When ejection of ink for one row is completed, the conveying rollers 1, 2 and 3, 4 transport the recording medium 5 by a predetermined row pitch in the direction A. In this manner, recording on the recording medium 5 is performed by repeating the transport of the recording medium 5 by the conveying rollers 1, 2 and 3, 4, the movement of the carriage, and ejection of ink from the recording head 6 alternately. After the completion of the recording, the recording medium 5 is discharged out from the recording apparatus by the operation of the conveying rollers 1, 2 and 3, 4. At the same time, the cap base 11 is moved upward by the driving unit, not shown, and the cap 14 gets into a capped state (see FIG. 4B) in which the cap adheres tightly to the contact portion 23 of the head face surface 21 of the recording head 6, and hermetically closes the nozzle tip portions 22 (Cap Close).

### [Detailed Description of Head Installation Operation of the Invention]

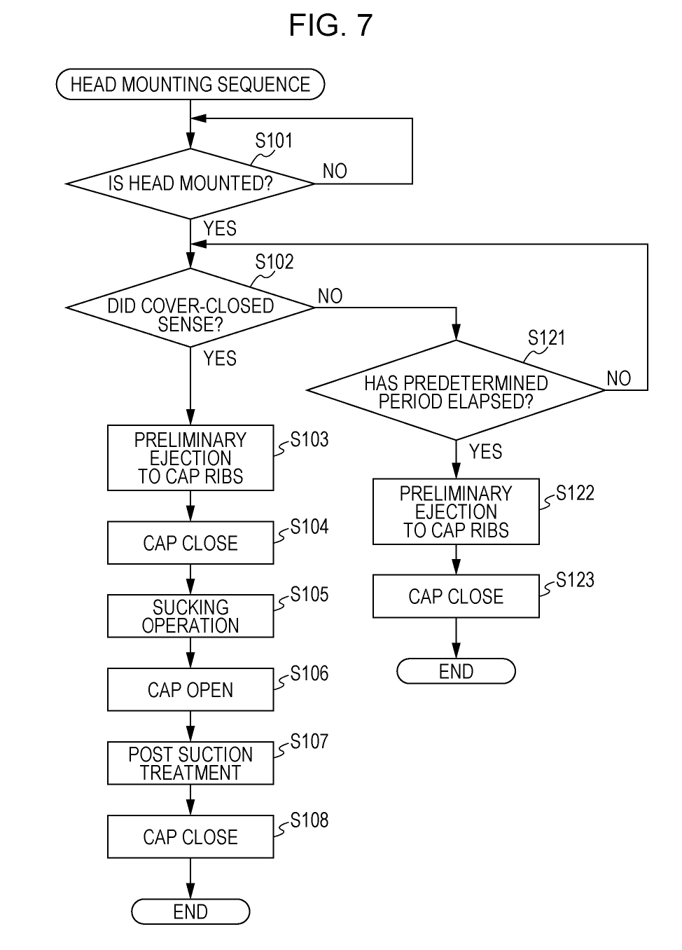

Referring now to a flowchart in FIG. 7, the head installation operation, which is the main characteristic of the invention, will be described in detail. The head installation operation described below solves a problem in the related art in that the cap 14 adheres to the head face surface 21 of the recording head 6 in the capped state after the cap-close operation, and the cap-open operation thereafter cannot be performed easily and smoothly.

In the embodiment, liquid-state ink containing less amount of color material (clear ink) is encapsulated in the recording head 6 before being mounted on a recording apparatus body. The clear ink serves to minimize changes of the state of the recording head 6 during transport or storage, and is used as liquid for preliminary ejection for preventing adhesion (liquid for preliminary ejection to cap ribs).

As described above, when the user puts power ON and opens the cover, then set the recording head 6 on the carriage moved to a position near the cover opening (S101) and then close the cover, the cover open-and-close sensor 108 senses the fact that the cover is closed (S102). Then, the recording head 6 ejects liquid (clear ink) from the recording head 6 onto a contact surface (cap rib) with respect to the head face surface 21 of the cap 14 at a position where the recording head 6 faces the cap 14 (S103). The operation to cause the recording head 6 to eject the liquid is preformed to prevent the cap 14 from adhering to the head face surface 21, and hence is referred to as “preliminary ejection for preventing adhesion”, and is also referred to as “preliminary ejection to cap ribs” because liquid is ejected toward the cap ribs in the embodiment.

Subsequently, the cap-close operation is performed to achieve the capped state (S104), then the sucking operation is performed to suck and discharge the clear ink from the recording head 6, and recording ink stored in the ink tank, not shown, is supplied to the recording head 6 (S105). In other words, the clear ink in the nozzle of the recording head 6 is replaced with the recording ink. Subsequently, the cap-open operation is performed to open the head face surface 21 (S106), and the preliminary ejection described above (preliminary ejection for recovery) and the wiping operation are performed (S107). Then, the cap-close operation is performed (S108), and the head installation operation is ended, thereby getting into a standby state in which the above-described recording operation is enabled.

There may be a case where the cover open-and-close sensor 108 does not sense that the cover is closed (cover close) (S102). In this case, if the state in which the cover close is not sensed continues for a predetermined time (S121), the cap-close operation is performed (S123) after the preliminary ejection to cap ribs (S122) as in Step S103 has performed to get into the capped state. Accordingly, a nozzle tip portions (ink ejecting portions) 22 of the recording head 6 mounted on the recording apparatus are protected.

In the head installation operation of the invention described thus far, the process of the preliminary ejection to cap ribs (S103, S122) is performed in addition to the general head installation operation in the related art. This is for preventing such event that the cap ribs and the head face surface 21 are adhered to each other after the cap-close operation (S104, S123) and hence the cap open operation thereafter cannot be performed smoothly. The process of the preliminary ejection to cap ribs (the process to cause liquid to be ejected) will be described further in detail.

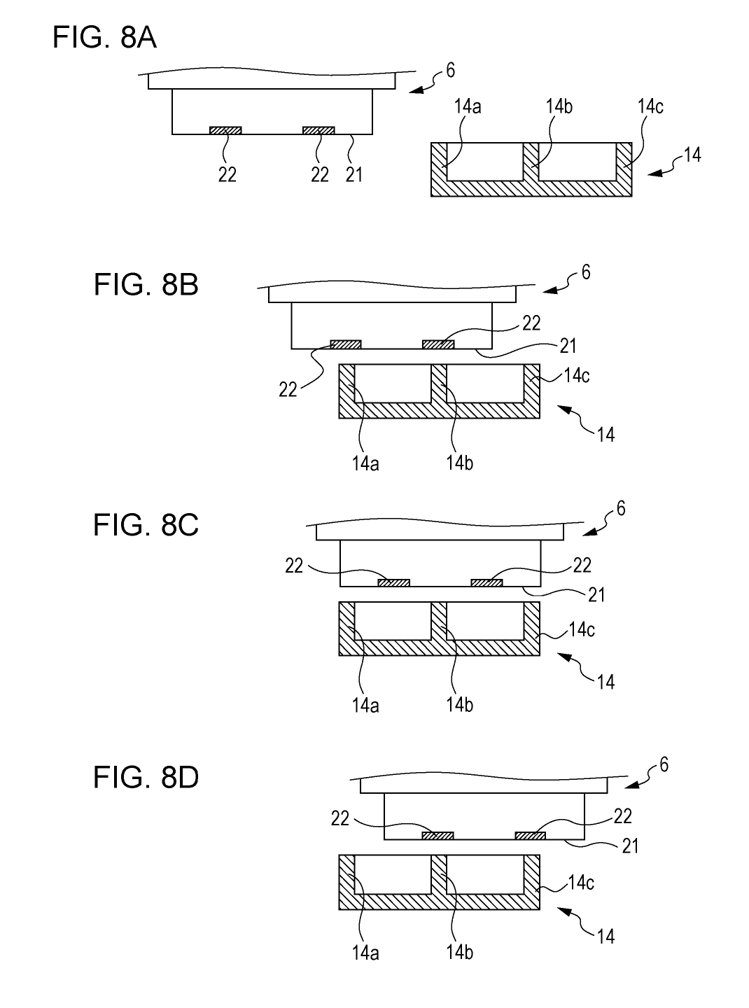

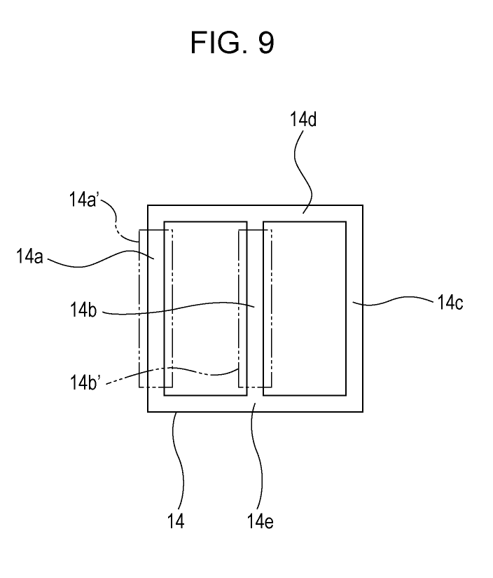

As shown in FIG. 8A, the recording head 6 moves from a position where the recording head 6 is away from the cap 14 as shown in FIG. 8A to a position where the nozzle tip portions 22 of the recording head 6 faces the cap ribs 14a and 14b of the cap 14 as shown in FIG. 8B. At that position, the recording head 6 ejects clear ink from the nozzle tip portions 22 toward the cap ribs 14a and 14b. Accordingly, the clear ink is adhered to the areas 14a′ and 14b′ including end surfaces of the cap ribs 14a and 14b shown in FIG. 9.

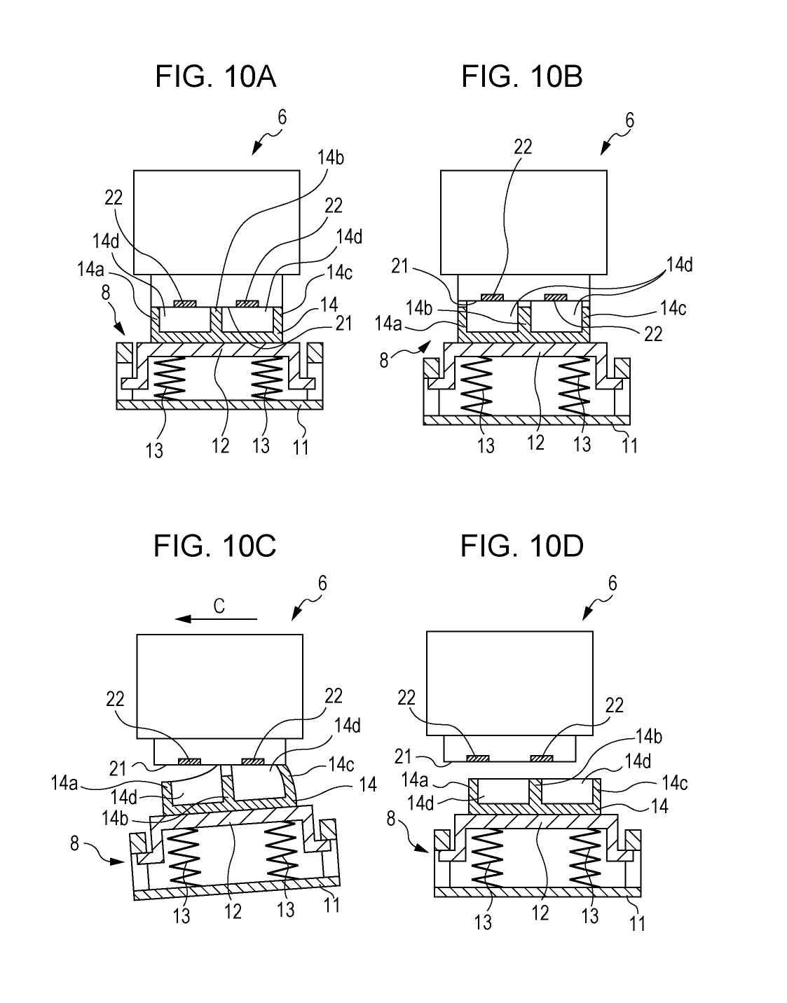

After the preliminary ejection to cap ribs 14a, 14b (S103, S122) have performed in this manner, the cap-close operation (S104, S123) is performed after having moved the recording head 6 to a position shown in FIG. 8C. When performing the cap-open operation (S106), the cap 14 is prevented from becoming difficult to be separated from the head face surface 21 of the recording head 6 thereafter. Referring now to FIG. 10, this point will be described below.

FIG. 10A shows a capped state after the preliminary ejection to cap ribs 14a and 14b (S103, S122) has performed and then the cap-close operation (S104, S123) has performed. Subsequently, when an attempt is made to move the cap base 11 downward by the driving unit, not shown, to perform the cap-open operation (S106), part of the cap 14 (the cap ribs 14a and 14b) moves away from the contact portion 23 of the recording head 6. Since the clear ink is adhered to the cap ribs 14a and 14b by the preliminary ejection to cap ribs (S103, S122), a layer of liquid (clear ink) is interposed between the end surfaces of the cap ribs 14a and 14b and the head face surface 21 of the recording head 6. The layer of the liquid (clear ink) prevents adhesion between the end surface of the cap ribs 14a and 14b and the head face surface 21.

However, since the preliminary ejection to cap ribs is not performed to the cap ribs 14c, 14d, and 14e is not performed and hence clear ink is not adhered thereto, adhesion occurs between the cap ribs 14c, 14d, and 14e and the head face surface 21. Consequently, as shown in FIG. 10B, even though part of the cap (the cap ribs 14a and 14b) is separated from the contact portion 23 of the recording head 6, remaining part (the cap ribs 14c, 14d, and 14e) is subjected to adhesion to the contact portion 23 of the recording head 6. When the recording head 6 is moved from this state in the direction C, that is, in the direction orthogonal to the direction in which the cap 14 moves toward or away from the recording head 6 as shown in FIG. 10C, the recording head 6 moves gradually away from the cap 14 while causing the entire portion of the cap unit 8 to incline. Along with this movement, the cap ribs 14d and 14e which are in adhesion to the head face surface 21 of the recording head 6 are separated gradually from a portion close to the cap ribs 14a and 14b (from the left side of FIG. 10C). When the recording head 6 is moved further in the direction C, the opened end 14c is separated from the head face surface 21 of the recording head 6 as shown in FIG. 10D. In this manner, the cap-open operation (S106) is completed.

In this manner, only with the preliminary ejection to cap ribs only to part of the cap ribs 14a to 14e, the cap-open operation can be performed without problem by using the movement of the recording head 6. Specifically, it is favorable to perform the preliminary ejection to cap ribs which causes the clear ink to adhere to the end surface of the closing panel 14a positioned in front (downstream side) in the direction of movement of the recording head 6 in the cap-open operation. It is because the end surface of the closing panel 14a serves as an original point of separation of the cap 14 from the head face surface 21 to easily realize the smooth cap-open operation. Then, since the amount of ink adhered to the end surfaces of the cap ribs 14a and 14b and hence consumed without contributing to recording is relatively small, efficiency in the use of ink is improved.

As shown in FIG. 8D, it is also applicable to perform the preliminary ejection to cap ribs (S104, S123) also at a position where the nozzle tip portions 22 of the recording head 6 face the opened end 14c to cause clear ink to adhere to the end surface of the opened end 14c. Furthermore, it is also applicable to perform the preliminary ejection also to the cap ribs 14d and 14e extending in the direction of movement of the recording head 6 to cause clear ink to adhere to the end surfaces thereof. In this operation, although the amount of consumption of ink increases, the cap-open operation can be performed further easily and smoothly. When the preliminary ejection is performed to the cap ribs 14d and 14e, clear ink is ejected while the recording head 6 is moving in the direction C.

As shown in the flowchart in FIG. 7, in the embodiment, the process of the preliminary ejection to cap ribs (S103, S122) is performed only before the first cap-close operation in the head installation operation performed when the recording apparatus is used for the first time. In other words, the process of the preliminary ejection to cap ribs is performed before the cap 14 in mint state is brought into contact with the head face surface 21 of the recording head 6 for the first time. Although it depends on the material of the cap 14, it is because the adhesion to the head face surface 21 of the recording head 6 occurs and the cap-open operation is hindered mostly when both of the recording head 6 and the cap 14 are unused, that is, in a dried state. Then, the reason why the process of the preliminary ejection to cap ribs (S103, S122) is not performed many times repeatedly is to prevent clear ink or recording ink from excessively adhering to the cap 14 and the interior of the recording apparatus from becoming prominently dirty. Furthermore, in the embodiment, since the ink ejected to the cap ribs in the process of the preliminary ejection to cap ribs is clear ink, the interior of the recording apparatus is prevented from becoming dirty. Since the clear ink is encapsulated in the recording head 6 in advance, the preliminary ejection to cap ribs can be performed even though the configuration is supposedly such that the ink tank is not mounted on the recording apparatus during the head installation operation. Accordingly, the adhesion between the recording head 6 and the cap 14 can be effectively prevented, and protection of the ink ejecting portions (nozzle tip portions 22) of the recording head 6 and release of protection by opening the same can be performed smoothly.

However, even when the normal recording ink is encapsulated in the recording head instead of the clear ink (liquid for preliminary ejection for preventing adhesion), adhesion between the recording head 6 and the cap 14 can be prevented by performing the process of the preliminary ejection to cap ribs using the recording ink.

Even after the use of the recording apparatus has started, it is also possible to perform the process of the preliminary ejection to cap ribs as described above before bringing the cap 14 into contact with the head face surface 21 of the recording head 6 for the first time after the recording head 6 mounted on the recording apparatus is replaced with another recording head 6. For example, occurrence of trouble at the time of replacement of the recording head 6 with a new recording head 6 when a problem occurs in the recording head 6 may be prevented. In this case, even though the head face surface 21 of the recording head 6 after the replacement is in the dried state, ink may remain on the cap ribs 14a to 14e. When ink remains on the cap ribs 14a to 14e, too strong adhesion does not occur even when adhesion between the recording head 6 and the cap 14 occurs. Therefore, in the process of the preliminary ejection to cap ribs at the time of replacement of the recording head as described above, sufficient effect is obtained even when the amount of ejection of the ink is reduced. In this configuration, the amount of consumption of ink for the preliminary ejection can be reduced.

When the problem of the dirt in the apparatus is not so serious, the process of the preliminary ejection to cap ribs can be performed using recording ink every time before the cap-close operation in association with the recording operation even after the head installation operation has ended. In this case, a higher effect can be obtained regarding the prevention of adhesion between the cap 14 and the recording head 6.

### [Modification of Cap Ribs]

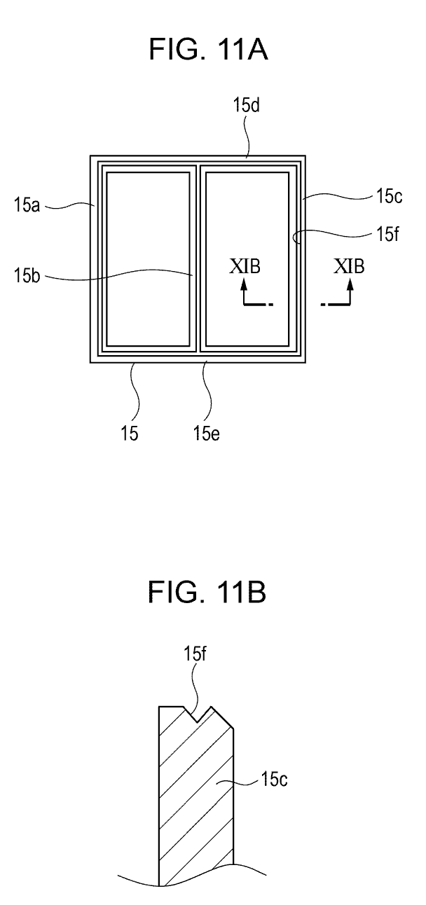

Cap ribs 15a to 15e of the cap 15 in the modification shown in FIGS. 11A and 11B are formed with a groove 15f along centers thereof over the entire area. In this configuration, when the preliminary ejection to cap ribs as described above is performed with respect to the cap ribs 15a, 15b, and 15c, clear ink (or recording ink) is dispersed along the groove 15f by capillary action. Then, when sufficient time is elapsed in a state of being left untouched, ink is distributed to the entire areas of the cap ribs 15a to 15e. When the cap-close operation is performed to achieve the capped state, the ink is interposed over the entire area of the contact surface between the recording head 6 and the cap 14, and hence adhesion between the recording head 6 and the cap 14 can be prevented.

According to the respective embodiments of the invention, the cap is prevented from becoming difficult to be separated from the recording head while hermetically sealing the periphery of the ejection port of the recording head by the cap without increasing manufacturing cost of the liquid ejection recording apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-193573 filed Aug. 31, 2010, which is hereby incorporated by reference herein in its entirety.

What is claimed is:

1. A liquid ejection recording apparatus comprising:
a recording head capable of ejecting liquid;
a cap capable of coming into contact with an ejection-port-formed surface of the recording head; and
a control unit configured to cause liquid to be ejected from the recording head on to a portion of the cap which comes into contact with the ejection-port-formed surface before bringing the cap into contact with the ejection-port-formed surface.

2. The liquid ejection recording apparatus according to claim 1, wherein the liquid is liquid of a type different from recording ink.

3. The liquid ejection recording apparatus according to claim 1, wherein the cap is formed with a groove at a portion coming into contact with the ejection-port-formed surface.

4. A method of maintenance of a liquid ejection recording apparatus including a recording head capable of ejecting liquid and a cap capable of coming into contact with an ejection-port-formed surface of the recording head, comprising:
a first step is performed before causing the recording head to eject liquid to a portion of the cap which comes into contact with the ejection-port-formed surface; and
a second step of bringing the cap into contact with the ejection-port-formed surface after the first step.

5. The method according to claim 4, wherein the first step of bringing the cap in mint state into contact with the ejection-port-formed surface.

6. The method according to claim 4, wherein the first step is performed before replacing the recording head and bringing the cap into contact with the ejection-port-formed surface of the recording head after the replacement for the first time.

7. The method according to claim 4, wherein when the liquid is caused to be ejected before bringing the cap into contact with the ejection-port-formed surface of the recording head after the replacement for the first time, the amount of liquid to be ejected from the recording head is set to be smaller than that in the case where the recording head is caused to eject liquid before bringing the cap in mint state into contact with the ejection-port-formed surface.

8. The method according to claim 4, wherein liquid different from recording ink is caused to be ejected in the first step.

9. The method according to claim 8, comprising a step of discharging liquid remained in the recording head and filling the recording head with recording ink after the second step.

10. The method according to claim 4, comprising a step of moving the recording head in the direction orthogonal to the direction of movement of the cap after the second step.
